(19) United States
(12) Patent Application Publication
(10) Pub. No.: US 2024/0179798 A1
(43) Pub. Date: May 30, 2024

(54) COMMUNICATION METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 18/431,684

(22) Filed: Feb. 2, 2024

Related U.S. Application Data
(63) Continuation of application No. PCT/JP2022/029551, filed on Aug. 1, 2022.
(60) Provisional application No. 63/228,266, filed on Aug. 2, 2021.

(51) Int. Cl. H04W 76/40; H04W 72/0453; H04W 76/20

(52) U.S. Cl. CPC H04W 76/40; H04W 72/0453; H04W 76/20

(57) ABSTRACT

A communication method according to a first aspect is a communication method used in a mobile communication system supporting a multicast broadcast service (MBS) and includes transmitting, at a user equipment performing MBS reception or being interested in the MBS reception in a radio resource control (RRC) connected state, an RRC message to a base station. The transmitting includes transmitting the RRC message including an information element indicating a mode desired by the user equipment as an MBS delivery mode or an MBS reception mode from the base station.

### RELATED APPLICATIONS

The present application is a continuation based on PCT Application No. PCT/JP2022/029551, filed on Aug. 1, 2022, which claims the benefit of U.S. Provisional Patent Application No. 63/228,266 filed on Aug. 2, 2021. The content of which is incorporated by reference herein in their entirety.

### TECHNICAL FIELD

The present disclosure relates to a communication method used in a mobile communication system.

### BACKGROUND OF INVENTION

The 3rd Generation Partnership Project (3GPP) standard has defined the technical specifications of NR (New Radio) positioned as the 5th generation (5G) radio access technology. NR has features such as high speed, large capacity, high reliability, and low latency compared to Long Term Evolution (LTE), which is a 4th-generation (4G) radio access technology. In the 3GPP, there is a discussion to formulate technical specifications of 5G/NR multicast broadcast service (MBS) (for example, see Non-Patent Document 1).

### CITATION LIST

### Non-Patent Literature

Non-Patent Document 1: 3GPP Contribution: RP-201038, “WID revision: NR Multicast and Broadcast Services”

### SUMMARY

A communication method according to a first aspect is a communication method used in a mobile communication system supporting a multicast broadcast service (MBS) and includes transmitting, at a user equipment performing MBS reception or being interested in the MBS reception in a radio resource control (RRC) connected state, an RRC message to a base station. The transmitting includes transmitting the RRC message including an information element related to a mode desired by the user equipment as an MBS delivery mode or an MBS reception mode from the base station.

A communication method according to a second aspect is a communication method used in a mobile communication system supporting a multicast broadcast service (MBS) and includes transmitting, at a user equipment performing MBS reception of a plurality of MBS sessions or being interested in the MBS reception in a radio resource control (RRC) connected state, an RRC message to a base station. The transmitting includes transmitting the RRC message including an information element that notifies the base station of a reception priority of each of the plurality of MBS sessions.

A communication method according to a third aspect is a communication method used in a mobile communication system supporting a multicast broadcast service (MBS) and includes transmitting, at a user equipment performing MBS reception or being interested in the MBS reception in a radio resource control (RRC) connected state, an RRC message to a base station. The transmitting includes transmitting the RRC message including an information element indicating whether multicast reception is to be prioritized over unicast reception even when the user equipment is participating in a multicast session.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a base station (gNB) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signalling (control signal).

FIG. 6 is a diagram illustrating an overview of MBS traffic delivery according to an embodiment.

FIG. 7 is a diagram illustrating delivery modes according to an embodiment.

FIG. 8 is a diagram illustrating a split MRB according to an embodiment.

FIG. 9 is a diagram illustrating an operation of a mobile communication system according to a first embodiment.

FIG. 10 is a diagram illustrating a configuration example of an RRC message according to the first embodiment.

FIG. 11 is a diagram illustrating another configuration example of the RRC message according to the first embodiment.

FIG. 12 is a diagram illustrating a part of an operation of the mobile communication system according to the first embodiment in a variation.

FIG. 13 is a diagram illustrating a variation of the first embodiment.

FIG. 14 is a diagram illustrating a configuration example of an RRC message according to a variation of the first embodiment.

FIG. 15 is a diagram illustrating an operation according to a second embodiment.

FIG. 16 is a diagram illustrating an overview of an aspect of stage 2 control plane in a delivery mode.

FIG. 17 is a diagram illustrating a one-step configuration of delivery mode 2.

FIG. 18 is a diagram illustrating MBMS interest indication (excluding a ROM-related configuration) in LTE.

FIG. 19 is a diagram showing the content of SIB13 of LTE.

FIG. 20 is a diagram showing the content of SIB13 of LTE.

FIG. 21 is a diagram showing the content of SIB13 of LTE.

FIG. 22 is a diagram showing the content of SIB15 of LTE.

FIG. 23 is a diagram showing the content of SIB20 of LTE.

FIG. 24 is a diagram showing the content of SC-MCCH of LTE.

FIG. 25 is a diagram showing the content of SC-MCCH of LTE.

FIG. 26 is a diagram showing the content of SC-MCCH of LTE.

FIG. 27 is a diagram showing the content of MBMS interest indication in LTE.

FIG. 28 is a diagram showing the content of MBMS interest indication in LTE.

FIG. 29 is a diagram showing the content of MBMS interest indication in LTE.

FIG. 30 is a diagram showing priorities of cell reselection of an eMBMS frequency in LTE.

FIG. 31 is a diagram showing priorities of cell levels in intra-frequency and intra-frequency cell reselection with an equal priority in NB-IOT in a CE (including eMTC) and in LTE for UE.

FIG. 32 is a diagram illustrating an example in which a QoffsetSCPTM is configured as an SCPTM frequency offset in SIB5.

### DESCRIPTION OF EMBODIMENTS

5G/NR multicast broadcast services are desired to provide enhanced services compared to 4G/LTE multicast broadcast services.

In view of this, the present disclosure provides a communication method for implementing enhanced multicast broadcast services.

A mobile communication system according to an embodiment is described with reference to the drawings. In the description of the drawings, the same or similar parts are denoted by the same or similar reference signs.

### First Embodiment

Configuration of Mobile Communication System

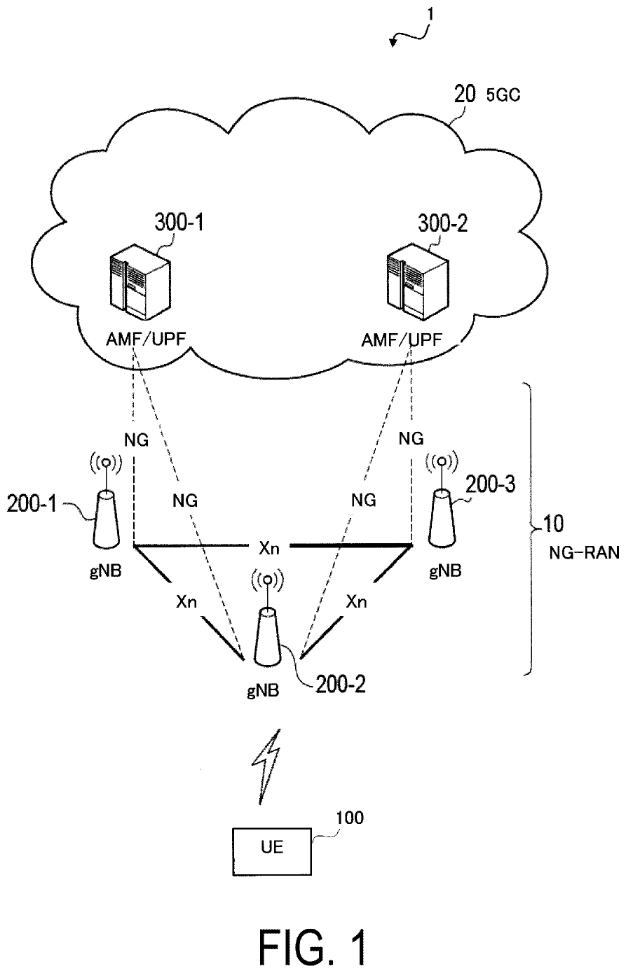

FIG. 1 is a diagram illustrating a configuration of a mobile communication system according to a first embodiment. A mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a user equipment (UE) 100, a 5G radio access network (Next Generation Radio Access Network (NG-RAN)) 10, and a 5G Core Network (5GC) 20. Hereinafter, the NG-RAN 10 is simply referred to as a “RAN 10”. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone), and/or a tablet terminal, a notebook PC, a communication module (including a communication card or a chipset), a sensor or an apparatus provided on a sensor, a vehicle or an apparatus provided on a vehicle (Vehicle UE), or a flying object or an apparatus provided on a flying object (Aerial UE).

The NG-RAN 10 includes a base station (referred to as a “gNB” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (also simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signalling. The UPF controls data transfer. The AMF and UPF are connected to the gNB 200 via an NG interface which is an interface between a base station and the core network.

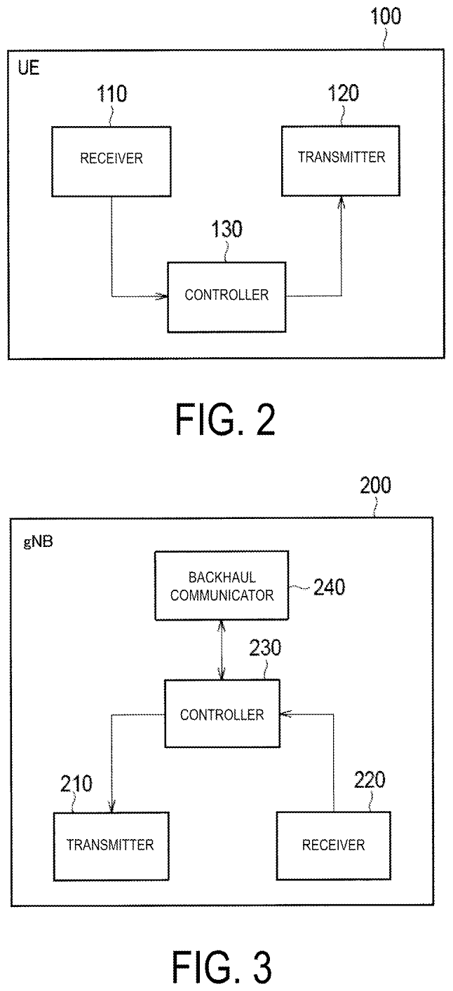

FIG. 2 is a diagram illustrating a configuration of the UE 100 (user equipment) according to the first embodiment. The UE 100 includes a receiver 110, a transmitter 120, and a controller 130. The receiver 110 and the transmitter 120 constitute a wireless communication section that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of controls and processing operations in the UE 100. Such processing includes processing of each layer to be described below. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing operations.

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communication section that performs wireless communication with the UE 100. The backhaul communicator 240 constitutes a network communication section that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of controls and processing operations in the gNB 200. Such processing includes processing of each layer to be described below. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing operations.

The backhaul communicator 240 is connected to a neighboring base station via an Xn interface that is an inter-base station interface. The backhaul communicator 240 is connected to the AMF/UPF 300 via an NG interface that is an interface between a base station and the core network. Note that the gNB 200 may include a Central Unit (CU) and a Distributed Unit (DU) (i.e., divided functions), and the both units may be connected via an F1 interface that is a fronthaul interface.

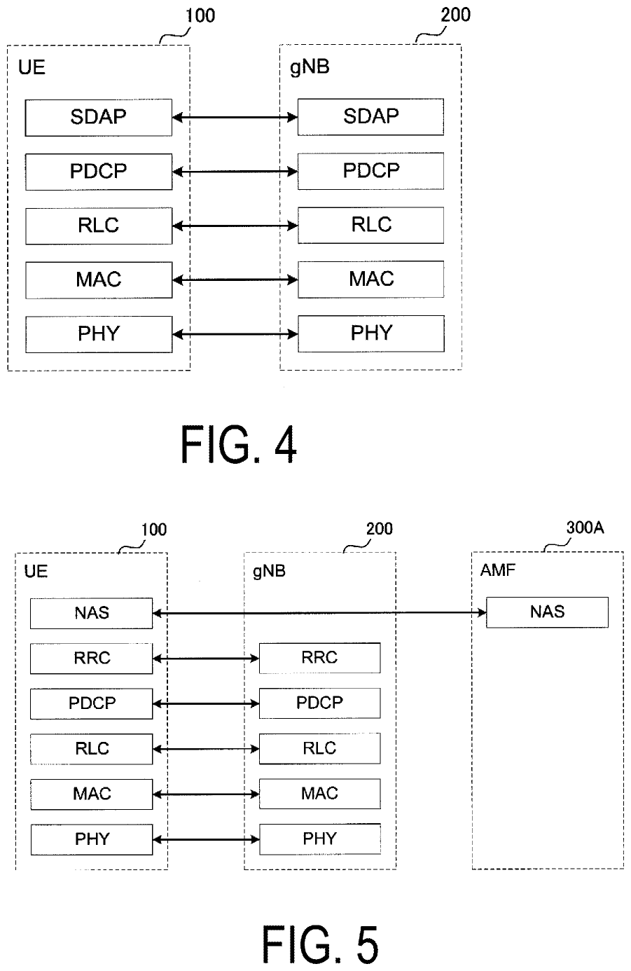

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind-decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through a hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

FIG. 5 is a diagram illustrating a configuration of a protocol stack of a radio interface of a control plane handling signalling (a control signal).

The protocol stack of the radio interface of the control plane includes a Radio Resource Control (RRC) layer and a Non-Access Stratum (NAS) layer instead of the SDAP layer illustrated in FIG. 4.

RRC signalling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection between the RRC of the UE 100 and the RRC of the gNB 200 (RRC connection) exists, the UE 100 is in an RRC connected state. When a connection between the RRC of the UE 100 and the RRC of the gNB 200 (RRC connection) does not exist, the UE 100 is in an RRC idle state. When the connection between the RRC of the UE 100 and the RRC of the gNB 200 is suspended, the UE 100 is in an RRC inactive state.

The NAS layer, which is positioned above the RRC layer, performs session management, mobility management, and the like. NAS signalling is transmitted between the NAS layer of the UE 100 and the NAS layer of the AMF 300A. Note that the UE 100 includes an application layer other than the protocol of the radio interface.

### Overview of MBS

An overview of an MBS according to the first embodiment will be described. The MBS is a service in which the NG-RAN 10 can provide broadcast or multicast, i.e., Point To Multipoint (PTM) data transmission to the UE 100. Note that use cases (service types) of the MBS include public safety communication, mission critical communication, Vehicle to Everything (V2X) communication, IPv4 or IPV6 multicast delivery, Internet Protocol Tele Vision (IPTV), group communication, and software delivery.

A broadcast service provides a service to every UE 100 within a particular service area for an application not requiring highly reliable QoS. An MBS session used for the broadcast service is referred to as a broadcast session.

A multicast service provides a service not to every UE 100, but to a group of UEs 100 participating in the multicast service (multicast session). An MBS session used in the multicast service is referred to as a multicast session. The multicast service can provide the same content to the group of UEs 100 through a method with higher radio efficiency, compared with the broadcast service.

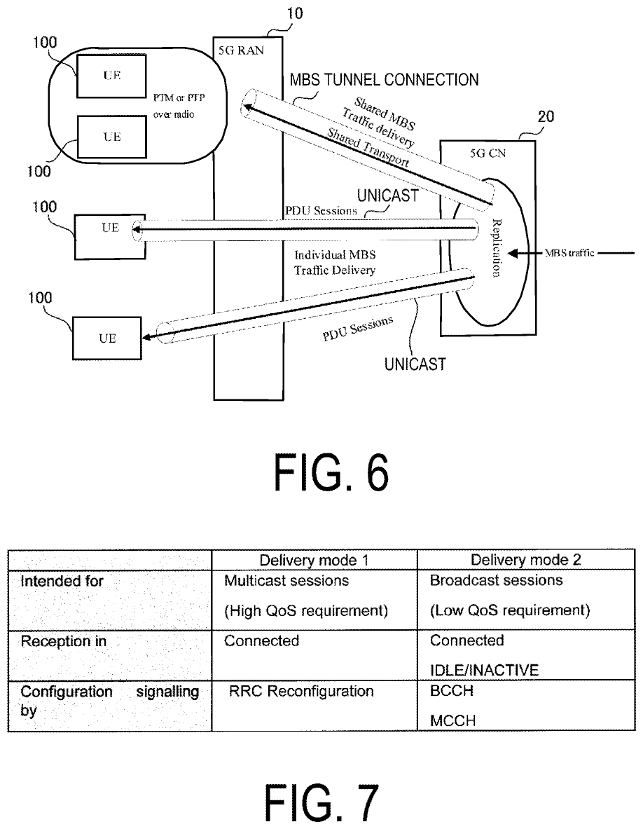

FIG. 6 is a diagram illustrating an overview of MBS traffic delivery according to the first embodiment.

MBS traffic (MBS data) is delivered from a single data source (application service provider) to a plurality of UEs. The 5G CN (5GC) 20, which is a 5G core network, receives the MBS data from the application service provider and creates a copy of the MBS data (Replication) to deliver the data.

From the perspective of the 5GC 20, two multicast delivery methods are possible: 5GC Shared MBS Traffic delivery and 5GC Individual MBS Traffic delivery.

In the 5GC individual MBS traffic delivery method, the 5GC 20 receives a single copy of MBS data packets and delivers individual copies of these MBS data packets to the individual UEs 100 via a PDU session of each UE 100. Thus, one PDU session for each UE 100 needs to be associated with a multicast session.

In the 5GC shared MBS traffic delivery method, the 5GC 20 receives a single copy of MBS data packets and delivers the single copy of the MBS packets to a RAN node (i.e., gNB 200). The gNB 200 receives the MBS data packets via an MBS tunnel connection and delivers the packets to one or more UEs 100.

From the perspective of the RAN (5G RAN) 10, two delivery methods are possible for wireless transmission of the MBS data in the 5GC shared MBS traffic delivery method, and the methods are a Point-to-Point (PTP) delivery method and a Point-to-Multipoint (PTM) delivery method. PTP means unicast and PTM means multicast and broadcast.

In the PTP delivery method, the gNB 200 wirelessly delivers the individual copies of the MBS data packets to the individual UEs 100. On the other hand, in the PTM delivery method, the gNB 200 wirelessly delivers the single copy of the MBS data packets to a group of the UEs 100. The gNB 200 dynamically determines which method between PTM and PTP needs to be used for one UE 100 as a method for delivering MBS data.

The PTP and PTM delivery methods are mainly related to the user plane. Modes for controlling the MBS data delivery include two delivery modes, which are a first delivery mode and a second delivery mode.

FIG. 7 is a diagram illustrating delivery modes according to the first embodiment.

The first delivery mode (Delivery mode 1: DM1) is a delivery mode that can be used by the UE 100 in the RRC connected state and is a delivery mode for a high QoS requirement. The first delivery mode is used only in multicast sessions among MBS sessions. However, the first delivery mode may also be used in broadcast sessions. The first delivery mode may be available to the UE 100 in the RRC idle state or the RRC inactive state.

A configuration for MBS reception in the first delivery mode is performed through UE-unique (UE-dedicated) signalling. For example, the configuration of MBS reception in the first delivery mode is performed through an RRC Reconfiguration message (or an RRC Release message), which is an RRC message transmitted in unicast from the gNB 200 to the UE 100.

The configuration of MBS reception includes MBS traffic channel configuration information (hereinafter referred to as “MTCH configuration information”) about the configuration of an MBS traffic channel carrying MBS data. The MTCH configuration information includes MBS session information relating to an MBS session and scheduling information of the MBS traffic channel corresponding to the MBS session. The scheduling information of the MBS traffic channel may include a discontinuous reception (DRX) configuration of the MBS traffic channel. The discontinuous reception configuration may include one or more parameters of a timer value (On Duration Timer) defining an On Duration (reception period), a timer value (Inactivity Timer) for extending the On Duration, a scheduling interval or DRX cycle (Scheduling Period or DRX Cycle), an offset value (Start Offset or DRX Cycle Offset) of a start subframe of the scheduling or DRX cycle, a start delay slot value (Slot Offset) of the On Duration Timer, a timer value (Retransmission Timer) defining a maximum time until retransmission, and a timer value (HARQ RTT Timer) defining a minimum interval until DL assignment of HARQ retransmission.

Note that the MBS traffic channel is a type of logical channel and may be referred to as an MTCH. The MBS traffic channel is mapped to a downlink shared channel (DL-SCH) that is a type of transport channel.

The second delivery mode (Delivery mode 2 or DM2) is a delivery mode that can be used not only by the UE 100 in the RRC connected state, but also by the UE 100 in the RRC idle state or the RRC inactive state and is a delivery mode for low QoS requirements. The second delivery mode is used for broadcast sessions among MBS sessions. However, the second delivery mode may also be applicable to multicast sessions.

A configuration of MBS reception in the second delivery mode is performed through broadcast signalling. For example, the configuration of the MBS reception in the second delivery mode is performed by a logical channel broadcast from the gNB 200 to the UE 100, for example, a broadcast control channel (BCCH) and/or a multicast control channel (MCCH). The UE 100 may receive the BCCH and the MCCH using a dedicated RNTI predefined in the technical specifications, for example. The RNTI for BCCH reception may be an SI-RNTI and the RNTI for MCCH reception may be an MCCH-RNTI.

In the second delivery mode, the UE 100 may receive MBS data in the following three procedures. First, the UE 100 receives MCCH configuration information through an SIB (MBS-SIB) transmitted on a BCCH from the gNB 200. Second, the UE 100 receives the MCCH from the gNB 200 based on the MCCH configuration information. The MCCH carries MTCH configuration information. Third, the UE 100 receives the MTCH (MBS Data) based on the MTCH configuration information. Hereinafter, the MTCH configuration information and/or the MCCH configuration information may be referred to as an MBS reception configuration.

In the first delivery mode and the second delivery mode, the UE 100 may receive the MTCH using a group RNTI (G-RNTI) allocated from the gNB 200. The G-RNTI corresponds to the RNTI for MTCH reception. The G-RNTI may be included in the MBS reception configuration (MTCH configuration information).

The network can provide different MBS services in each of MBS sessions. The MBS session is identified by at least one selected from the group consisting of a Temporary Mobile Group Identity (TMGI), a source specific IP multicast address (including a source unicast IP address of an application function, an application server, or the like and an IP multicast address indicating a destination address), a session identifier, and the G-RNTI. At least one selected from the group consisting of the TMGI, the source specific IP multicast address, and the session identifier is referred to as an MBS session identifier. The TMGI, the source specific IP multicast address, the session identifier, and the G-RNTI are collectively referred to MBS session information.

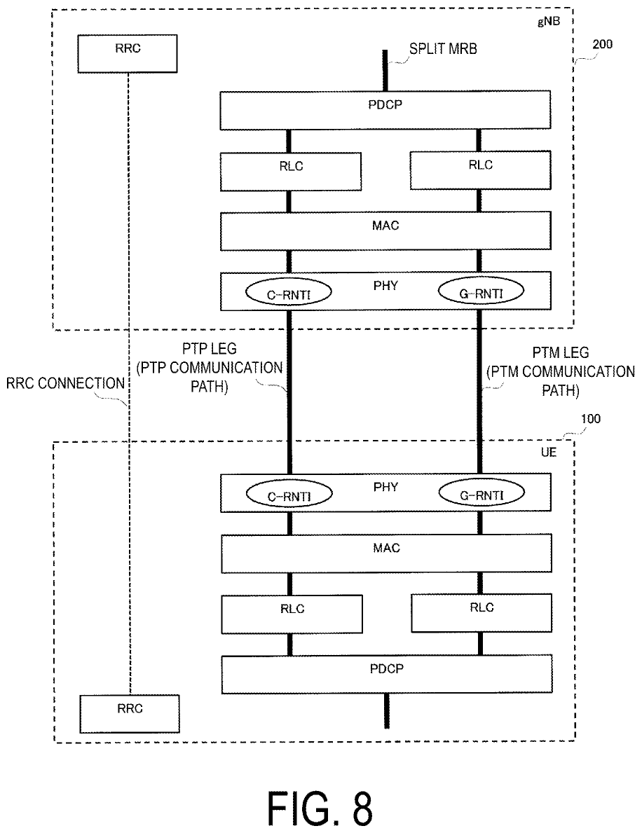

FIG. 8 is a diagram illustrating a split multicast radio bearer (MRB) according to the first embodiment. The MRB may be a type of a data radio bearer (DRB). The split MRB may be used in the first delivery mode described above.

The gNB 200 may configure an MRB split into a PTP communication path and a PTM communication path for the UE 100. This allows the gNB 200 to dynamically switch the transmission of the MBS data to the UE 100 between the PTP (PTP communication path) and the PTM (PTM communication path). The gNB 200 may perform duplication transmission of the same MBS data using both the PTP (PTP communication path) and the PTM (PTM communication path) to enhance reliability. Hereinafter, the PTP communication path is referred to as a PTP leg, and the PTM communication path is referred to as a PTM leg. A functional unit corresponding to each layer is referred to as an entity.

A predetermined layer terminating the split is the MAC layer (HARQ), the RLC layer, the PDCP layer, or the SDAP layer. Although an example in which the predetermined layer terminating the split is the PDCP layer will be mainly described below, the predetermined layer may be the MAC layer (HARQ), the RLC layer, or the SDAP layer.

Each of the PDCP entity of the gNB 200 and the PDCP entity of the UE 100 splits an MRB which is a bearer (data radio bearer) used for the MBS into a PTP leg and a PTM leg. Note that the PDCP entity is provided for each bearer.

Each of the gNB 200 and the UE 100 includes two RLC entities provided for the respective legs, one MAC entity, and one PHY entity. The PHY entity may be provided per leg. Note that, in Dual Connectivity in which the UE 100 communicates with two gNBs 200, the UE 100 may include two MAC entities.

The PHY entity transmits and/or receives data of the PTP leg using a Cell Radio Network Temporary Identifier (cell RNTI or C-RNTI) that is allocated to the UE 100 on a one-to-one basis. The PHY entity transmits and/or receives data of the PTM leg using the G-RNTIs allocated to the MBS sessions on a one-to-one basis. Although a C-RNTI is different depending on each UE 100, a G-RNTI is an RNTI common to a plurality of UEs 100 receiving one MBS session.

In order to perform PTM transmission of the MBS data (multicast or broadcast) from the gNB 200 to the UE 100 using the PTM leg, a split MRB needs to be configured for the UE 100 from the gNB 200 and the PTM leg needs to be activated (activation). In other words, even if a split MRB is configured for the UE 100, when a PTM leg is in a deactivated state, the gNB 200 cannot perform PTM transmission of the MBS data using the PTM leg.

For the gNB 200 and the UE 100 to perform PTP transmission of the MBS data (unicast) using the PTP leg, a split MRB needs to be configured for the UE 100 from the gNB 200 and the PTP leg needs to be activated. In other words, even if a split MRB is configured for the UE 100, when the PTP leg is in a deactivated state, the gNB 200 cannot perform PTP transmission of the MBS data using the PTP leg.

When the PTM leg is in an activated state, the UE 100 monitors a PDCCH to which the G-RNTI associated with the MBS session is applied (i.e., performs blind decoding of the PDCCH using the G-RNTI). The UE 100 may monitor the PDCCH only at a scheduling occasion of the MBS session.

When the PTM leg is in a deactivated state, the UE 100 does not monitor a PDCCH to which a G-RNTI associated with the MBS session is applied (i.e., does not perform blind decoding of the PDCCH using the G-RNTI).

When the PTP leg is in an activated state, the UE 100 monitors a PDCCH to which a C-RNTI is applied. When Discontinuous Reception (DRX) in the PTP leg is configured, the UE 100 monitors a PDCCH for a configured OnDuration period. When a cell (frequency) associated with the MBS session is specified, the UE 100 may monitor a PDCCH for the cell even when the cell is deactivated.

When the PTP leg is in a deactivated state, the UE 100 may monitor a PDCCH to which a C-RNTI is applied in preparation for normal unicast downlink transmission other than the MBS data. Note that, when a cell (frequency) associated with an MBS session is specified, the UE 100 need not monitor a PDCCH for the MBS session.

Note that the above-described split MRB is assumed to be configured by an RRC message (for example, an RRC Reconfiguration message) transmitted by the RRC entity of the gNB 200 to the RRC entity of the UE 100.

### Operation of Mobile Communication System

An operation of the mobile communication system 1 according to the first embodiment will be described.

Examples of delivery mode for MBS data include the first delivery mode and the second delivery mode as described above. Each MBS session is delivered by the gNB 200 in either the first delivery mode or the second delivery mode. There is a possibility of the UE 100 not being able to simultaneously receive a plurality of MBS sessions with different delivery modes applied thereto while being able to simultaneously receive a plurality of MBS sessions. Furthermore, in the second delivery mode, the UE 100 can receive an MBS even when the UE 100 is in the RRC idle state or the RRC inactive state, and the second delivery mode may be preferable for UE 100 desiring to receive an MBS with low-power consumption. Therefore, appropriate and efficient MBS delivery is considered to be achieved if the gNB 200 can ascertain the delivery mode desired by the UE 100.

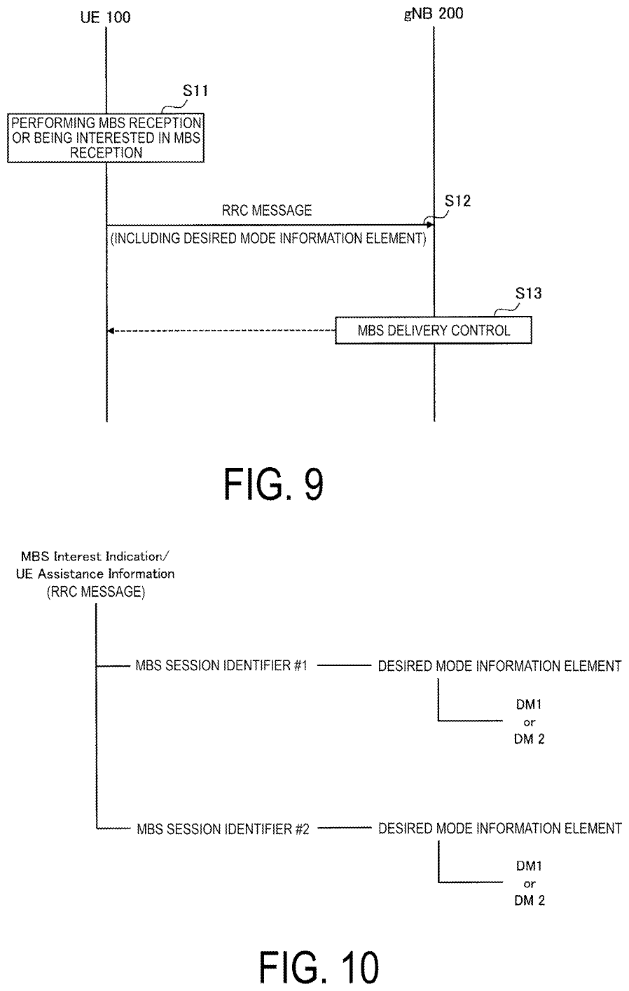

FIG. 9 is a diagram illustrating an operation of the mobile communication system 1 according to the first embodiment. The UE 100 is assumed to be in an RRC connected state in a cell (serving cell) of the gNB 200.

In step S11, the UE 100 is in a state of receiving an MBS or being interested in receiving an MBS.

In step S12, the UE 100 generates an RRC message and transmits the generated RRC message to the gNB 200. The gNB 200 receives the RRC message. The RRC message is, for example, a message that the UE 100 can spontaneously transmit, and may be an MBS Interest Indication message or a UE Assistance Information message.

Here, the UE 100 transmits the RRC message including an information element (hereinafter referred to as a “desired mode information element”) indicating a mode desired by the UE 100 as an MBS delivery mode from the gNB 200 or an MBS reception mode. As a result, since the gNB 200 can ascertain the MBS delivery mode or the MBS reception mode desired by the UE 100 based on the desired mode information element included in the received RRC message, appropriate and efficient MBS delivery becomes possible.

The RRC message may include identifiers of one or more MBS sessions in which the UE 100 is performing MBS reception or is interested in MBS reception (MBS session identifiers) and a desired mode information element associated with each of the one or more MBS session identifiers. That is, the RRC message may include information in which an MBS session (MBS session identifier) in which the UE 100 is performing MBS reception or is interested in MBS reception is associated with a desired mode (desired mode information element).

The desired mode information element may be an information element indicating a delivery mode desired by the UE 100 from among a plurality of delivery modes as MBS delivery modes. For example, the desired mode information element may be an information element indicating the delivery mode desired (prioritized) by the UE 100 from among the first delivery mode and the second delivery mode. The desired mode information element may be an information element indicating preference of the delivery mode and/or an information element indicating the priorities of the delivery modes (e.g., prioritize reception in the first delivery mode over that in the second delivery mode).

Here, the first delivery mode is an example of a delivery mode for a multicast session, and the second delivery mode is an example of a delivery mode for a broadcast session. In addition, the first delivery mode is an example of a delivery mode for the RRC connected state, and the second delivery mode is an example of a delivery mode for all RRC states (the RRC connected state, the RRC idle state, and the RRC inactive state). Furthermore, the first delivery mode is an example of a delivery mode in which an MBS reception configuration is made by using UE-dedicated signalling from the gNB 200, and the second delivery mode is an example of a delivery mode in which an MBS reception configuration is made by using broadcast signalling from the gNB 200.

FIG. 10 is a diagram illustrating a configuration example of an RRC message according to the first embodiment. The RRC message includes association of an MBS session identifier on which the UE 100 is performing or is interested in MBS reception with desired mode information elements. FIG. 10 illustrates an example in which the RRC message includes an MBS session identifier #1 and an MBS session identifier #2,and the desired mode information elements are associated with the MBS session identifiers. Each of the desired mode information elements indicates one of the first delivery mode and the second delivery mode.

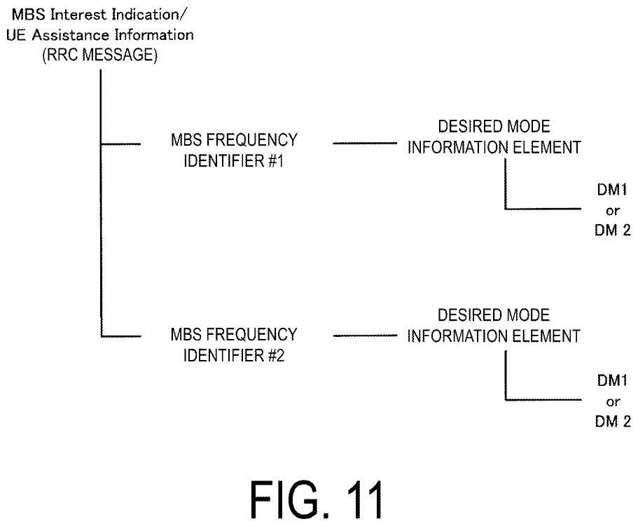

Alternatively, the desired mode information elements may be associated with MBS frequency identifiers (or cell identifiers) instead of or in addition to the MBS session identifiers. For example, as illustrated in FIG. 11, an RRC message may include one or more MBS frequency identifiers (or cell identifiers) on which the UE 100 is performing MBS reception or is interested in MBS reception, and desired mode information elements associated with each of the one or more MBS frequency identifiers (or cell identifiers).

The desired mode information elements may be information elements indicating that the UE 100 desires low-power consumption MBS reception as an MBS reception mode. Accordingly, the gNB 200 can ascertain that the UE 100 desires the low-power consumption MBS reception based on the desired mode information elements included in the received RRC message. The desired mode information elements may include at least one of the following pieces of information.
Information indicating that a predetermined QoS may not be satisfied.
Information indicating that low-power consumption MBS reception is desired.
Information indicating that the second delivery mode is desired:

It indicates that the UE 100 desires to receive an MBS in the RRC idle state/RRC inactive state.
Information indicating that the UE desires PTP reception in the first delivery mode: In the case of the split MRB illustrated in FIG. 8, the PTP leg reception is always in the ON state to perform unicast reception, but the PTM leg reception requires additional power consumption. In addition, because a plurality of pieces of UE perform in PTM while MCS is optimized similarly to unicast in PTP, a longer time and/or a larger number of reception operations are required, without optimization of an MCS. For this reason, low-power consumption operations can be realized by performing only PTP reception in the first delivery mode.
Information indicating a desire not to switch from PTP to PTM.
Information indicating a desire to turn off feedback from the UE 100 to the gNB 200 (e.g., HARQ feedback).
Information indicating that reception of a certain MRB is not desired.

Referring back to FIG. 9, in step S13, the gNB 200 performs one of the following MBS delivery control operations based on the desired mode information elements included in the RRC message received from UE 100 in step S12.

### Change of the Delivery Mode of a Certain MBS Session:

For example, the gNB 200 changes the MBS session in which delivery is performed in the second delivery mode to one in the first delivery mode. Alternatively, the gNB 200 changes the MBS session in which delivery is performed in the first delivery mode to one in the second delivery mode. The change to the second delivery mode may be intended for low-power consumption MBS reception.

The UE 100 performs handover:

For example, the gNB 200 hands over UE 100 desiring to receive a certain MBS session in the second delivery mode to a cell that delivers the MBS session in the second delivery mode. Alternatively, the gNB 200 hands over UE 100 desiring to receive a certain MBS session in the first delivery mode to a cell that delivers the MBS session in the first delivery mode.

### Scheduling, Configuration Change, or the Like is Performed to Enable Low-Power Consumption MBS Reception:

For example, the gNB 200 provides a certain MBS session in PTP. The gNB 200 may set the UE 100 to turn off feedback.

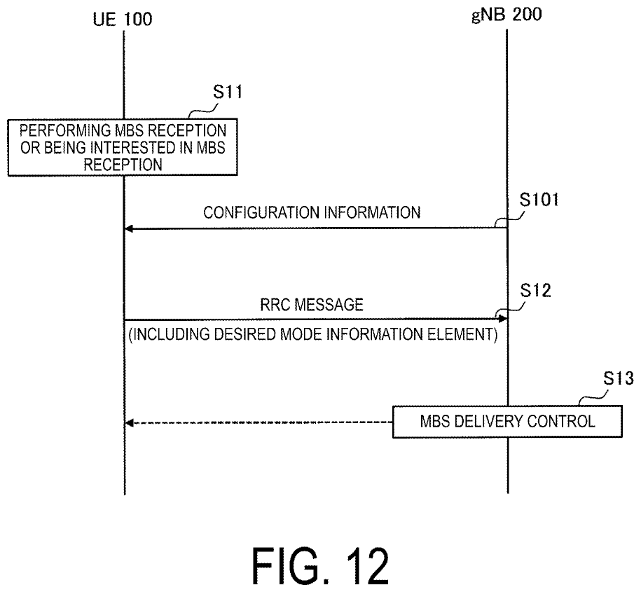

FIG. 12 is a diagram illustrating a part of an operation of the mobile communication system 1 according to the first embodiment in a variation.

In step S101, the gNB 200 transmits configuration information indicating that transmission of an RRC message including desired mode information elements is allowed to the UE 100. The gNB 200 may transmit the configuration information through UE-dedicated signalling (RRC Reconfiguration message) or broadcast signalling (SIB or MCCH).

The UE 100 may be allowed to transmit the desired mode information elements (step S12) only when such permission has been granted. The UE 100 may transmit the desired mode information elements (step S12) only when the condition that the remaining battery level is less than or equal to a threshold is satisfied. The threshold may be set by the gNB 200 for the UE 100.

According to the first embodiment, the UE 100 transmits, to the gNB 200, an RRC message including desired mode information elements indicating a mode desired by the UE 100 as an MBS delivery mode from the gNB 200 or an MBS reception mode. As a result, since the gNB 200 can ascertain the MBS delivery mode or the MBS reception mode desired by the UE 100 based on the desired mode information elements included in the received RRC message, appropriate and efficient MBS delivery becomes possible.

### Variation of First Embodiment

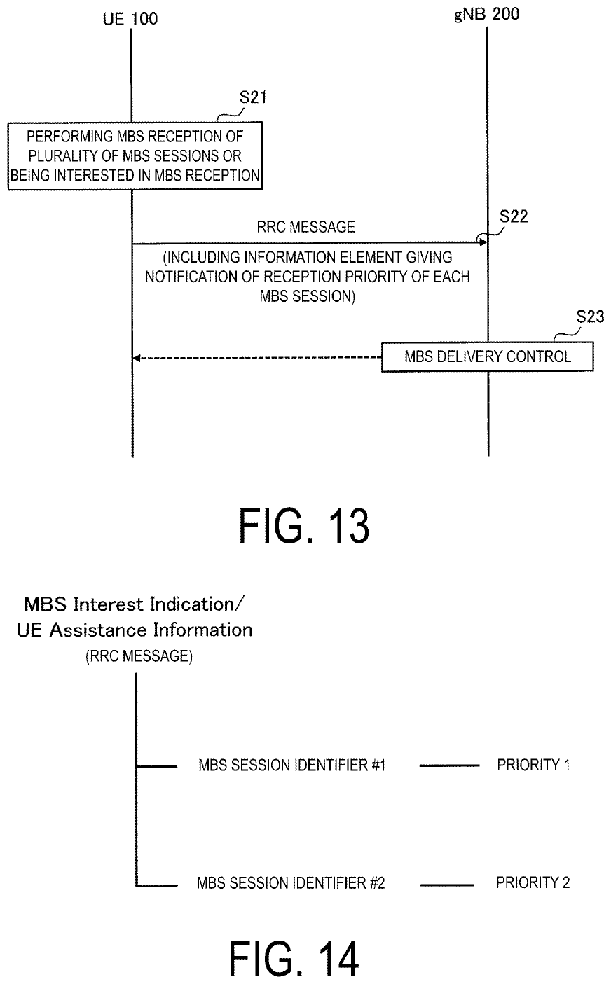

A variation of the first embodiment will be described focusing on differences from the first embodiment. FIG. 13 is a diagram illustrating a variation of the first embodiment. The UE 100 is assumed to be in an RRC connected state in a cell (serving cell) of the gNB 200.

In step S21, the UE 100 is in a state of receiving an MBS in a plurality of MBS sessions or being interested in the MBS reception.

In step S22, the UE 100 generates an RRC message and transmits the generated RRC message to the gNB 200. The gNB 200 receives the RRC message. The RRC message is, for example, a message that the UE 100 can spontaneously transmit, and may be an MBS Interest Indication message or a UE Assistance Information message.

Here, the UE 100 determines the reception priority of each of the MBS sessions and transmits the RRC message including information elements notifying the gNB of the reception priority of each of the MBS sessions. The reception priority for each of the MBS sessions may be notified of from the NAS layer to the AS layer. The AS layer may notify the gNB 200 of the reception priority notified from the NAS layer.

FIG. 14 is a diagram illustrating a configuration example of an RRC message according to the present variation. The RRC message includes association of an MBS session identifier on which the UE 100 is performing MBS reception or is interested in MBS reception with priorities. FIG. 14 illustrates an example in which the RRC message includes an MBS session identifier #1 and an MBS session identifier #2,and the priorities (reception priorities) are associated with the MBS session identifiers. Here, the priority of the MBS session identifier #1 is the highest priority, and the priority of the MBS session identifier #2 is the second priority.

Alternatively, the reception priorities may be associated with MBS frequency identifiers (or cell identifiers) instead of the MBS session identifiers or in addition to the MBS session identifiers. For example, the RRC message may include one or more MBS frequency identifiers (or cell identifiers) on which the UE 100 is performing MBS reception or is interested in MBS reception, and priority information associated with each of the one or more MBS frequency identifiers (or cell identifiers).

Instead of explicitly notifying the gNB 200 of the priorities, the gNB 200 may be implicitly notified of the priorities. For example, the RRC message may include a list of MBS session identifiers (or MBS frequency identifiers, or cell identifiers) arranged in order of priorities. In this case, the positions of the entries on the list represent priorities.

Referring back to FIG. 13, in step S23, the gNB 200 performs the above-described MBS delivery control based on the information elements included in the RRC message received from UE 100 in step S22. For example, the gNB 200 may handover the UE 100. When the gNB 200 itself (own cell) does not provide an MBS session having a high priority, the gNB 200 may handover the UE 100 to another cell providing the MBS session.

Note that the gNB 200 may transmit configuration information indicating that transmission of the RRC message including the information elements is allowed to the UE 100 as in FIG. 12.

### Second Embodiment

A second embodiment will be described focusing on differences from the first embodiment.

In the second embodiment, a UE 100 in an RRC connected state is mainly assumed to receive MBS data transmitted in multicast from a gNB 200 (i.e., multicast data) in the first delivery mode. Thus, an MBS session is assumed to be a multicast session. A multicast session may be mapped to a PTM leg or a PTM bearer (MRB). Note that an MBS traffic channel (MTCH) is used in transmission of multicast data from the gNB 200 to the UE 100.

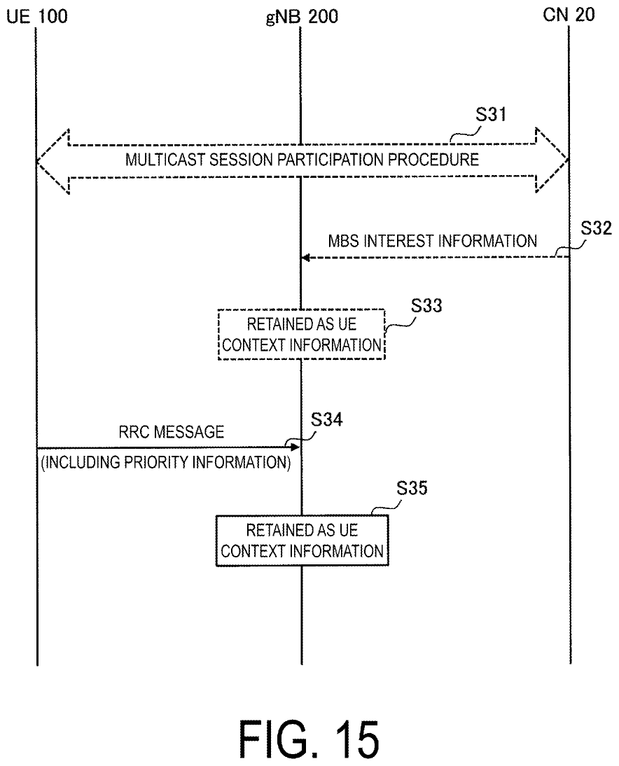

FIG. 15 is a diagram illustrating an operation according to a second embodiment. The UE 100 is assumed to be in an RRC connected state in a cell (serving cell) of the gNB 200.

In step S31, the UE 100 in the RRC connected state is assumed to be interested in a certain multicast session (hereinafter referred to as a “target multicast session”). “Being interested in a multicast session” means that an upper layer of the UE 100 requests or desires to receive a multicast session. The upper layer includes the NAS layer. The upper layer may further include an application. The UE 100 (NAS entity) may perform a multicast session participation procedure for a network (CN 20) to participate in the target multicast session. For example, the UE 100 participates in the target multicast session by transmitting a first NAS message requesting participation in the target multicast session to an AMF 300A and receiving a second NAS message approving participation in the target multicast session from the AMF 300A. “Participate in the target multicast session” means to register the UE 100 in a CN apparatus as a member of a UE group (multicast group) that receives a multicast session. Note that participation in the multicast session may be performed while the multicast session is in a valid state (during transmission) or in an invalid state (while a start of transmission is waited, or transmission is interrupted).

In step S32, the CN 20 (AMF 300A) may notify the gNB 200 of MBS interest information (MBS frequencies, MBS session identifiers, and the like) of the UE 100.

In step S33, the gNB 200 may retain the information from the CN 20 as UE context information of the UE 100.

As described above, when the UE 100 is participating in a multicast session, the gNB 200 can acquire the MBS interest information (MBS frequencies, MBS session identifiers, and the like) of the UE 100 from the CN 20, and thus the necessity of transmitting the MBS interest information (RRC message) from the UE 100 to the gNB 200 is considered to be low. However, there is a concern about the gNB 200 not being able to acquire priority information indicating whether multicast reception (MBS reception) is to be prioritized over unicast reception from the CN 20.

In step S34, the UE 100 transmits an RRC message including information elements indicating whether multicast reception is to be prioritized over unicast reception to the gNB 200 even when the UE is participating in a multicast session. The gNB 200 receives the RRC message. The RRC message is, for example, a message that the UE 100 can spontaneously transmit, and may be an MBS Interest Indication message or a UE Assistance Information message.

As a result, the gNB 200 acquires priority information indicating whether multicast reception (MBS reception) is to be prioritized over unicast reception from the UE 100 and can ascertain whether the UE 100 prioritizes multicast reception (MBS reception) over unicast reception.

In step S35, the gNB 200 retains information elements included in the RRC message received in step S34 as the UE context information of the UE 100.

Note that, although the UE 100 has been described as participating in a multicast session, when UE 100 is not participating in a multicast session, the gNB 200 is considered as not being able to acquire MBS interest information (MBS frequencies, MBS session identifiers, and the like) of the UE 100 from the CN 20. Therefore, for example, when the UE 100 in the RRC connected state is receiving a broadcast session or is interested in receiving a broadcast session, the UE 100 is assumed to notify the gNB 200 of MBS interest information (MBS frequencies, MBS session identifiers, and the like) of the UE 100.

That is, when the UE 100 is not participating in a multicast session, the UE 100 transmits, to the gNB 200, an RRC message including information elements indicating whether multicast reception (MBS reception) is to be prioritized over unicast reception and other information elements indicating MBS sessions and/or MBS frequencies on which the UE 100 is performing MBS reception or is interested in MBS reception (step S34). On the other hand, when the UE 100 is participating in a multicast session, an RRC message not including the other information elements but including information elements indicating whether multicast reception (MBS reception) is to be prioritized over unicast reception is transmitted to the gNB 200 (step S34).

According to the second embodiment, the UE 100 transmits an RRC message including information elements indicating whether multicast reception is to be prioritized over unicast reception to the gNB 200 even when the UE is participating in a multicast session. Accordingly, in a situation where the gNB 200 can acquire MBS interest information (MBS frequencies, MBS session identifiers, and the like) from the CN 20, priority information that the gNB 200 cannot acquire from the CN 20 can be provided from the UE 100 to the gNB 200.

### OTHER EMBODIMENTS

The operation flows described above can be separately and independently implemented, and also be implemented in combination of two or more of the operation flows. For example, some of the steps in one operation flow may be applied to another operation flow. Some of the steps in one operation flow may be replaced with some of the steps in another operation flow.

Although an example in which the base station is an NR base station (i.e., gNB) has been described in the embodiment and examples described above, the base station may be an LTE base station (i.e., eNB) or a 6G base station. The base station may be a relay node such as an Integrated Access and Backhaul (IAB) node. The base station may be a DU of an IAB node. A user equipment may be a mobile termination (MT) of the IAB node.

A program causing a computer to execute each of the processing operations performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, System on a chip (SoC)).

The phrases “based on” and “depending on” used in the present disclosure do not mean “based only on” and “only depending on”, unless specifically stated otherwise. The phrase “based on” means both “based only on” and “at least partially based on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise”, and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure for translation, these articles are assumed to include the plural unless clearly indicated otherwise in context.

Embodiments have been described above in detail with reference to the drawings, but specific configurations are not limited to those described above, and various design variation can be made without departing from the gist of the present disclosure.

### Supplementary Note

### 1. Introduction

RAN #88 has approved revised work items that are related to the NR multicast and broadcast service (MBS).

RAN2 has agreed on two delivery modes. That is, the modes are delivery mode 1 of a multicast session received by UE in the connected state and delivery mode 2 of a broadcast session received by all UEs in the RRC state.

RAN2 has also agreed on the details of the MCCH scheduling method, that is, the MCCH repetition period, the MCCH transmission window, the search space, and the MCCH modification period.

RAN2 #114-e reached the following agreement about the two delivery modes.

PCCH is used for multicast activation notification (also used for MBS support nodes). Transmission of the MBS session ID is confirmed in the notification.

Use of paging in all (legacy) POs using PRNTI is a baseline assumption (other changes can also be discussed).

An MBS-specific SIB is defined to perform an MCCH configuration.

The content of an MCCH needs to include information about a broadcast session such as a G-RNTI and an MBS session ID, and schedule information of an MTCH (search space, DRX, and the like).

An L1 parameter that needs to be included in the MCCH are reserved for further progress and input of RAN1.

The discussion of whether a dedicated MCCH configuration is needed is deferred until RAN1 proceeds with BWP/CFR of the MCCH.

An indication of an MCCH modification due to a modification in the configuration of an ongoing session (including session termination) is provided in an explicit notification from a network (if RAN1 confirms that, in addition to the bits for the session start notification, another bit for this purpose can be accommodated in the MCCH modification notification DCI). Whether this notification can be reused to change other information carried by the MCCH needs further consideration.

Whether the possibility that the UE misses the MCCH modification notification needs to be addressed or whether it can be left to the UE implementation needs further consideration.

At least if RAN1 determines to utilize an RNTI other than an MCCH-RNTI for the MCCH modification notification, the MCCH modification notification is transmitted in the first MCCH monitoring occasion of each MCCH repetition period.

A single MCCH is supported.

This supplementary note provides details of the aspects of the control plane of delivery mode 2, taking the baseline of the LTE eMBMS mechanism into account.

### 2. Discussion

### 3. Remaining Problems of Stage 2

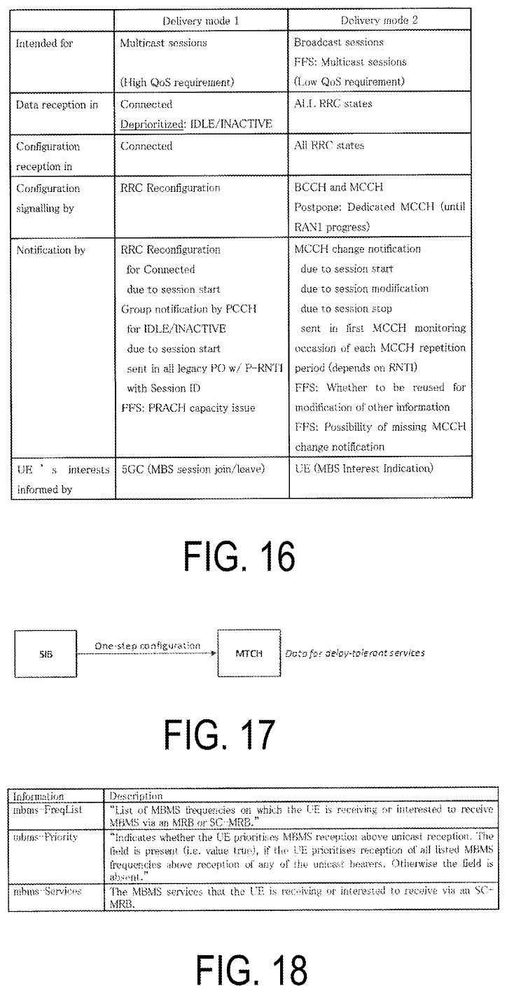

At this point, features of the two delivery modes are described in FIG. 16 in accordance with the agreement of RAN2.

### 4. Multicast Session Connected Via Delivery Mode 2

The NR MBS is expected to support various types of use cases as quoted in the following WID. The NR MBS needs to be appropriately designed for a variety of requirements ranging from delay-sensitive applications such as mission critical and V2X to delay-tolerant applications such as IoT. As software delivery to UDP type streaming such as IPTV, actually not all multicast services require “high QoS”.

An object A of the SA2 SI relates to activation of general MBS services via 5GS, and use cases that are recognized to be likely to benefit from this function include public safety, mission critical cases, V2X applications, transparent IPv4/IPv6 multicast delivery, IPTV, and software delivery via wireless communications, group communications, and IoT applications.

Although some of these services with “low QoS requirements” may be covered by delivery mode 2, other services with “high QoS requirements” need delivery mode 1. The LTE eMBMS may deliver a multicast session, which may be considered a baseline for the NR MBS. In this sense, selection of use of delivery mode 2 for multicast sessions is advantageous to the gNB. Although this problem needs to be further considered from RAN2 #112-e to RAN2 #114-e, in general there seems to be no technical reason to restrict them.

Although RAN2 has agreed on that “RAN2 agreed that active multicast support in the RRC connected mode of Rel-17 is preferred, and if time is allowed, multicast support in RRC inactive state can be discussed later (multicast solution in connected mode and broadcast solution more mature)”, since the agreement was made in the context of delivery mode 1, it does not exclude a multicast session in delivery mode 2 of UE in a connected state.

Proposal 1: RAN2 needs to agree that delivery mode 2 can be used at least in multicast sessions of the UE in the RRC connected state in addition to broadcast sessions.

### 5. Dedicated MCCH (from the Viewpoint of Service Continuity)

The RAN2 has agreed that “the discussion on whether a dedicated MCCH configuration is needed is delayed until RAN1 develops in the BWP/CFR of the MCCH”. The dedicated MCCH is expected to be provided through, for example, an RRC reconfiguration if supported.

Observation 1: A dedicated MCCH is provided by a RRC reconfiguration of an MCCH. That is, it can be interpreted that the method is not a broadcast-based method.

On the other hand, the dedicated MCCH can be considered from the viewpoint of continuity of the broadcast service. RAN2 has already agreed that “the PTM configuration of NR MBS delivery mode 2, i.e., the broadcast-based method, is assumed to be able to be received by reusing the LTE SC-PTM mechanism of the UE in the connected state is assumed”. Although this assumption relates to an intra-cell configuration, it is not related to continuity of inter-cell services, i.e., handover.

Observation 2: Although the MCCH that RAN2 has agreed is provided in a broadcast-based method for the intra-cell configuration, it is not for continuity of inter-cell services.

In LTE SC-PTM, the UE is assumed to acquire the SIB20 and MCCH of a target cell in some way before, during, or even after a handover. This may be regarded as the baseline of NR MBS delivery mode 2. However, this means that there is a risk of service interruption because the UE may miss or delay acquiring the MCCH of a neighboring cell, for example, in a busy state. Therefore, it is worth discussing more reliable solutions. Specifically, the MCCH of the target cell, at least the target MTCH scheduling information, needs to be provided by an RRC reconfiguration using synchronization, i.e., a handover command. This solution can reliably ensure service continuity after a handover.

Proposal 2: RAN2 needs to agree that the MCCH of a target cell, at least target MTCH scheduling information, is to be provided during the handover procedure. That is, it is provided by a RRC reconfiguration using synchronization to ensure continuity of inter-cell services for a UE in the RRC connected state.

### 6. MCCH Modification Notification Related to Other Information

RAN2 agrees to introduce an MCCH modification notification by session start, session change and stop, to currently intend that the MCCH modification notification is transmitted when the configuration related to MTCH reception (e.g., MBS session information and MTCH scheduling information) is modified. RAN2 commented “whether this notification can be reused to modify other information carried by the MCCH needs to be further considered”.

Possible “other information” can be interpreted as neighboring cell/frequency information, which will be discussed in the following section. If the UE misses a neighboring cell/frequency information, this is not a significant problem when the UE remains in the serving cell. However, the latest neighboring cell/frequency information is important information in case of inter-cell mobility of UEs in the idle/inactive state and UEs in the RRC connected state if proposal 5 is not agreed on. In this sense, for more reliable service continuity, if RAN2 agreed that the neighboring cell/frequency information is provided by the MCCH, the MCCH modification notification also needs to be transmitted even when other information is modified.

Proposal 3: RAN2 needs to agree that the MCCH modification notification is transmitted when any of the content of the MCCH is modified. That is, in addition to MBS session information and MTCH scheduling information, it is also applied to “other information” which is at least adjacent frequency/cell information (if it is agreed to be provided by MCCH).

### 7. Missed MCCH Modification Notification

RAN2 commented “whether the UE needs to address the possibility of missing the MCCH modification notification or whether it can be left to the UE implementation needs further consideration”. According to the agreement, the MCCH modification notification is expected to be provided in the DCI, but the details are up to RAN1.

What needs for further consideration relates not only to session modification/termination, but also to session initiation, which has not been recognized as a problem in LTE eMBMS. Whether the problem actually exists may depend on the DCI design of RAN1. For example, an MCCH modification notification may be transmitted even when the MCCH has not been modified. For example, a bit in DCI can be “0” to indicate “no modification” and “1” to indicate “modified”, and thus the UE can be notified of whether an MCCH modification has been missed. The notification may be given without additional power consumption and some actions for recovery can be performed. Therefore, whether RAN2 needs to discuss the need for further consideration at this time is unclear.

Observation 3: Before RAN2 discusses the possibility of the UE missing the MCCH modification notification, RAN1 progress status in the DCI design of the MCCH modification notification is required.

### 8. On-Demand MCCH

A new paradigm of NR supports on-demand SI transmission. This concept may be reused for the MCCH in delivery mode 2, i.e., on-demand MCCH. For example, the MCCH for delay-tolerant services is provided on demand, thus enabling optimization of resource consumption by signalling. Of course, the network includes another option for providing the MCCH periodically, rather than on-demand of delay-sensitive services, and the like.

Proposal 4: RAN2 needs to agree that an MCCH can be provided on demand.

### 9. One-Step Configuration

As another possibility, merging an MCCH with a BCCH, i.e., one-step configuration as illustrated in FIG. 17, may be studied further. For example, the SIB provides MTCH scheduling information directly, i.e., without the MCCH. Delay-tolerant services and optimization of power-sensitive UEs are provided. For example, the UE can request the SIB (on-demand), and the gNB can start providing the SIB and the corresponding service after requests from the plurality of UEs. These UEs do not need to monitor the repeatedly broadcast MCCH.

Proposal 5: RAN2 needs to agree on that multicast reception without the MCCH is supported (i.e., one-step configuration). For example, the SIB provides MTCH scheduling information directly.

### 10. Counting in Idle/Inactive State

For the NR MBS, although the support for the MBS interest indication in the RRC connected state has been agreed, the MBS interest indication in the idle/inactive state is not supported. Based on this, it is worthwhile to study function enhancement, in addition to the LTE eMBMS.

In the LTE eMBMS, even when most of the UEs receive broadcast services in the RRC idle state, information of neither the MII nor count can be collected from the UEs in the idle state. This is one remaining problem of the LTE eMBMS from the viewpoint of session control and resource efficiency.

Observation 4: For a broadcast session, most UEs receiving the MBS service may be in the RRC idle/inactive state.

In the NR MBS, the same problem may occur in the UE in the idle/inactive state, i.e., in delivery mode 2 of broadcast sessions. For example, the network does not recognize whether the UE in the idle/inactive state is not receiving/interested in broadcast services. Thus, the network may continue to provide PTM transmission even when no UEs are receiving services. When the gNB recognizes benefits of the UE in the idle/inactive state, such unnecessary PTM transmission needs to be avoided. Conversely, when the PTM stops while the UE in the idle/inactive state receiving services are still present, many UEs may transmit connection requests simultaneously, which is also undesirable.

Accordingly, it is worthwhile to study whether to introduce a mechanism for collecting UE assistance information, specifically the MBMS count, from the UE in the idle/inactive state. Needless to say, that the UEs in the idle/inactive state is capable of reporting information without transitioning to the RRC connected state is desirable. For example, this may be achieved when the PRACH resource partitioning associated with the MBS service is introduced to such a report.

It is be noted that NR MBS does not have MCE, and this means that the MCE function is integrated in the gNB. In this sense, RAN2 determines whether the count is required in the NR MBS, regardless of what RAN3 has determined from the viewpoint of the network interface.

Proposal 6: RAN2 needs to discuss whether the MBS count is to be introduced and also collected from the UE in the idle/inactive state.

### 11. Aspect of Stage 3

A cell reselection procedure in SIB13, SIB15, SIB20, SC-MCCH, MBMS interest indication IE, and LTE can be regarded as the baseline of the stage 3 specifications of the NR MBS.

### 12. MBS-Specific SIB

### 13. Basic Content

RAN2 has agreed that “MBS-specific SIBs are defined to perform an MCCH configuration”. Regarding the MCCH configuration, RAN2 has already agreed that “an MCCH transmission window is defined by an MCCH repetition period, an MCCH window period, and a radio frame/slot offset” and “a modification period is defined for an NR MCCH”. These parameters are the same as those of the SIB20 and they are, i.e., an SC-MCCH-repetition period, an SC-MCCH-first subframe, an SC-MCCH-period, an SC-MCCH-offset, and an SC-MCCH-modification period, respectively. The ranges of these parameters can be easily reused to minimize standardization efforts.

Proposal 7: RAN2 needs to agree that, in the MBS-specific SIB, the ranges of MCCH repetition period, period, radio frame/offset, and modification period reuse the range of these parameters of the LTE SC-PTM, i.e., SIB20.

### 14. Advanced Content

Whether the MBS service is provided in PTP or PTM and whether it is provided in delivery mode 1 or delivery mode 2 depends on the implementation of a NW. This provides a good balance between service reliability and spectral efficiency. However, from the viewpoint of a UE, especially for a UE in the idle/inactive state and a UE joining late, the UEs need to know whether it needs to start connection establishment to acquire a target MBS service. The UEs check the MCCH first, and if the MCCH does not contain MTCH scheduling information of the target MBS service, the UEs may consider to be aware of the fact that the MBS service is only provided in the RRC connected state, i.e., via PTP, delivery mode 1 or unicast (PDU session). However, such a process is a burden for the UEs and may cause some degree of delay before acquiring the MBS service. Therefore, it is worth discussing whether the MBS-specific SIB provides information on whether the UEs need to be connected to acquire the MBS service.

Proposal 8: RAN2 needs to discuss whether the MBS-specific SIB provides information for associating MBS services with their delivery modes.

RAN2 has agreed to introduce MBS interest indications that are assumed to be used in broadcast sessions. At least from the viewpoint of AS, it is up to the network whether the MBS service is provided as a multicast session or a broadcast session. Furthermore, from the viewpoint of the UE, whether the gNB can acquire information about the MBS service that the UE is interested in is unclear, which may be provided by the AMF for multicast sessions, but not for broadcast sessions. As a result, the UE cannot know whether the MBS interest indications need to be transmitted for the MBS service of interest. Therefore, it is useful for the UE if the gNB provides information about whether the MBS interest indications are allowed for each MBS service. In other words, which MBS service needs the MBS interest indication is the key. Therefore, RAN2 needs to discuss whether such additional information is needed.

Proposal 9: RAN2 needs to discuss whether the MBS-specific SIB provides information about whether the MBS interest indication can be transmitted to each MBS service.

### 15. MCCH

RAN2 “has agreed on the fact that the content of an MCCH needs to include information about a broadcast session such as a G-RNTI and an MBS session ID, and schedule information of an MTCH (search space, DRX, and the like). An L1 parameter that needs to be included in the MCCH are pending progress and input of RAN1”, and “discussion of whether a dedicated MCCH configuration is needed is postponed until RAN1 progresses in the BWP/CFR of the MCCH”.

For the MTCH scheduling information, the SC-MCCH of the LTE SC-PTM includes SC-MTCH-InfoList including MBMS Session Info (TMGI and session ID), g-RNTI, and SC-MTCH-scheduling Info (On Duration Timer SCPTM, DRX-Inactivity Timer SCPTM, Scheduling Period Start Offset SCPTM). Since RAN2 has agreed that “in the case of NR MBS delivery mode 2, the LTE SC-PTM DRX scheme is used as the baseline”, these parameters and value ranges are simply reused to minimize standardization efforts.

Proposal 10: RAN2 needs to agree that the MCCH provides MBS Session Info (TMGI and session ID), G-RNTI and MTCH-scheduling Info (On Duration Timer, Inactivity Timer, Scheduling Period and Start Offset) as MTCH information.

Proposal 11: RAN2 needs to agree that a value range of each parameter of the MTCH scheduling information (that is, On Duration Timer, Inactivity Timer, Scheduling Period, and Start Offset) is the same as those parameters of the LTE SC-PTM, that is, the SC-PTM configuration.

In LTE eMBMS, SIB15 provides inter-frequency information in SAI, that is, an MBMS-SAI-inter-frequency list. In LTE SC-PTM, the SC-MCCH includes an SCPTM-neighboring cell list including a cell ID and a frequency and an SC-MTCH neighboring cell list which is a bit string for referring to the neighboring cell list. These pieces of information are useful for service continuity, i.e., MBMS interest indications and cell reselection priority processing, from the viewpoint of the UE.

Such neighboring cell/frequency information is regarded as being continuously useful in NR MBS for the same purpose, i.e., service continuity. Therefore, RAN2 needs to agree on the cell/frequency list on which the MBS service is broadcast. Since the UE needs to know the cell/frequency on which the target MBS service is provided, the neighboring cell/frequency information needs to be associated with the MBS session ID (such as TMGI). For example, the cell/frequency list further associated with SAI such as an LTE eMBMS needs further consideration, and whether it is broadcast via an MBS-specific SIB or MCCH also needs further consideration.

Proposal 12: RAN2 needs to agree that the neighboring cell/frequency list associated with the MBS session ID (such as TMGI) is broadcast for service continuity. Whether it is further associated with SAI and whether it is provided on an MBS-specific SIB or MCCH needs further consideration.

### 16. MBS Interest Indication

### 17. Basic Content

Although RAN2 has agreed to “assume that an MBS interest indication is supported by UEs in a connected mode of a broadcast service”, the exact content has not yet been discussed.

In LTE, an MBMS interest indication includes three IEs except for a ROM-related configuration (as shown in FIG. 18). This assistance information helps to ensure service continuity, such as scheduling of the gNB and decision on handovers. Since the characteristics of SC-PTM and delivery mode 2 are very similar, the same information is regarded as useful for NR MBS.

Proposal 13: RAN2 needs to agree that the MBS interest indication includes a list of frequencies, priorities between MBS reception and unicast, and a list of MBS services, similar to the MBMS interest indication of LTE.

Since the minimum MBS service area may be a cell of the NR MBS, whether the MBS interest indication also needs to include a list of cells providing MBS services in which the UE is interested is considered. In LTE SC-PTM, since the gNB provides neighboring cell information, assuming that the gNB knows which neighboring cell provides which MBS service, MBMS service means such a cell. The same assumption applies to NR MBS, especially if proposal 9 can be agreed upon. Therefore, RAN2 needs to verify the gNB.

Proposal 14: If the MBS service list is included in the MBS interest indication, RAN2 needs to confirm that it means the cell providing the MBS service in which the UE is interested, that is, that the gNB knows the MBS service to be provided by the neighboring cell is assumed.

### 18. Advanced Content

In addition to the LTE baseline, i.e., the above proposals 13 and 14, it is worth considering whether the MBS interest indication needs to provide other assistance information.

For example, the MBMS priority may be used to indicate whether the UE prefers MBMS reception to unicast reception, which may be helpful for scheduling gNB and may be reused in NR MBS, for example. However, there are two delivery modes for NR MBS, that is, delivery mode 1 using C-RNTI and delivery mode 2 using G-RNTI, which are based on different scheduling algorithms for MTCH transmission. Thus, if a UE is interested in multiple MBS services provided via different delivery modes, it may be helpful for the UE to provide priority between reception in delivery mode 1 and reception in delivery mode 2. Other examples may also be considered, such as the power saving configuration of the UE described as needed. Therefore, RAN2 first needs to discuss whether additional information for advanced purposes is provided by the MBS interest indication.

Proposal 15: RAN2 needs to discuss whether additional information is provided by an MBS interest indication, for example, priorities between reception in delivery mode 1 and reception in delivery mode 2.

### 19. Definition of Message

Another issue worth considering is whether an MBS interest indication is a new/separate message or integrated with a UE assistance information message. In LTE, MBMS interest indications (MIIs) are separated from the UE assistance information (UAI) due to preconditions being different, i.e., to obtain SIB15 of the MIIs during RRC connection reconfiguration of UAI. On the other hand, the In-deviceCoexistenceIndication (IDC), which is a separate message in LTE, is integrated into UAI of NR. Since the preconditions for LTE (and NR) were the same between IDC and UAI, i.e., the RRC connection reconfiguration is the same, they are feasible.

Observation 5: Whether the MBS interest indication can be integrated with the UE assistance information depends on whether the preconditions are coordinated between two messages.

In the case of NR MBS, neighboring cell/frequency information of an MBS-specific SIB or MCCH as in Proposal 9 is needed to generate an MBS interest indication message in the IE of Proposal 10. That the MBS interest indication is configured in an MBS-specific SIB, the same SIB (or MCCH) as in the case of LTE eMBMS is expected. Therefore, it is not consistent with the precondition of UAI, i.e., an RRC reconfiguration. Therefore, the MBS interest indication needs to be a separate message from the UAI, like the LTE eMBMS.

Proposal 16: RAN2 needs to agree to define the MBS interest indication as a new message, i.e., separately from the UE assistance information.

Proposal 17: RAN2 needs to agree that transmission of the MBS interest indication is allowed if the UE can acquire the MBS-specific SIB from a serving cell (i.e., as a precondition).

### 20. MBS Interest Indication of Multicast Session

RAN2 assumes that MBS interest indications are supported in broadcast sessions but are not supported in multicast sessions. In the case of a multicast session, it is generally understood that the core network informs the gNB of the interest of the UE because the multicast session has an upper layer session join procedure. In the context of Proposal 10 and FIG. 18, it applies to the MBS services of interest of the UE. If Proposal 11 can be agreed on, that the gNB knows the MBS frequency and the cell providing the MBS service of interest of the UE is clear. However, because the priority between MBS reception and unicast is similar to the priority of LTE MBMS, it is purely AS-related information, i.e., it is strange for the UE to notify the core network of the priority information in the session join procedure, they may not be provided by the core network.

Observation 6: For a multicast session, the core network provides a gNB of interest of the UE, such as an MBS service, and the gNB knows the MBS frequency/cell, but the core network and the gNB may not know the AS priority of the UE between MBS and unicast.

The priority information is still regarded as useful for the gNB, e.g., for scheduling and handover decisions as well as for LTE eMBMS, which is also related to service continuity. Therefore, the UE needs to inform the gNB of the priority information also for multicast sessions. In this sense, RAN2 needs to agree that the multicast service/delivery mode 1 also needs to support MBS interest indications.

Proposal 8: RAN2 needs to agree that the MBS interest indication is also supported in multicast session/delivery mode 1, at least for the UE to inform the gNB of the priorities of MBS reception and unicast.

### 21. Cell Reselection

### 22. Priority Processing of Cell Reselection

In LTE eMBMS, for inter-frequency cell reselection, a so-called “highest priority rule” is applied to priority processing of cell reselection. In particular, the UE may regard the frequency for providing the MBMS service of interest as the highest priority. The UE can regard a frequency at which an MBMS service of interest is not provided as the lowest priority. Regardless of the absolute frequency priority configured by the eNB, the UE can reselect the cell providing a target MBMS service, thus ensuring service continuity. These rules apply only at the frequency level, and that the MBMS service is provided for each frequency can be sufficiently assumed.

Observation 7: In LTE, service continuity is guaranteed by a UE that can regard the frequency for providing the target MBMS service as highest priority, which can be applied to inter-frequency cell reselection.

Observation 8: In LTE, the UE can also regard the frequency for not providing a target MBMS service as the lowest priority, which can be applied to inter-frequency cell reselection.

Furthermore, for intra-frequency and inter-frequency cell reselection having equal-priority, NB-IOT of CE, and UE (i.e., enhanced coverage), the R criterion (i.e., ranking) applies a SC-PTM specific offset, which can be configured to be “infinity”. This mimics the “highest priority rule” for each cell. This means that “the UE is in enhanced coverage because the defined ranking applies to intra-frequency and inter-frequency cell reselection (regardless of the configured frequency priority)”, i.e., inter-frequency cell reselection of the past cannot be applied to NB-IOT of CE and UE.

Observation 9: In LTE, a UE of NB-IOT and a UE of CE apply a SC-PTM specific offset (which may be “infinity”) to the R criterion. This can be applied to intra-frequency and inter-frequency cell reselection at the same priority.

In summary, there are two mechanisms in LTE that can be applied to inter-frequency cell reselection (i.e., frequency-based) and intra-frequency and inter-frequency reselection at an equal priority (i.e., cell-based), respectively. The “highest priority rule” for inter-frequency cell reselection is simple to introduce in NR MBS because, similar to LTE eMBMS, UEs in idle/inactive states need to camp on the frequency providing the target MBS service. Therefore, RAN2 needs to agree on introducing the “highest priority rule” for the NR MBS. The “lowest priority rule” as in Observation 5 needs to be introduced.

Proposal 19: RAN2 needs to agree that, similar to LTE, the frequencies at which the UE provides the target MBS service may be regarded as having the highest priority.

Proposal 20: RAN2 needs to agree that, similar to LTE, the frequencies at which the UE does not provide the target MBS service may be regarded as having the lowest priority.

### 23. R Criterion

Another mechanism, that is, the SC-PTM specific offset of the R criterion, is worth taking into account that the minimum service area of the NR MBS is regarded as a cell, but still depends on the development scenario preferred in Rel-17, i.e., a frequency-based or cell-based one. Frequency-based development, i.e., provision of the same MBS service between cells at frequencies within a particular MBS service area, is a subset of cell-based development. That is, since the MBS service can represent a frequency on a list of cells, the MBS service is provided only in a cell, so that the list includes all cells on the frequency. Thus, if MBS services are provided basically for each cell, flexibility for supporting different development scenarios increases.

As described above, the SC-PTM specific offset was introduced for multicast support in eMTC/NB-IOT in Rel-14, i.e., no inter-frequency cell reselection in CE, but can be used to prioritize specific cells. An MBMS service of interest is provided. Therefore, the same mechanism can be reused to prioritize the cell providing the MBS service of interest of the UE, thereby reducing standardization efforts.

Proposal 21: RAN2 needs to agree that an MBS-specific offset can be applied to the R criterion in order to prioritize a specific cell providing the MBS service of interest of the UE, and thus the offset can be set to “infinity”, similar to LTE.

### APPENDIX

### SIB13 of LTE

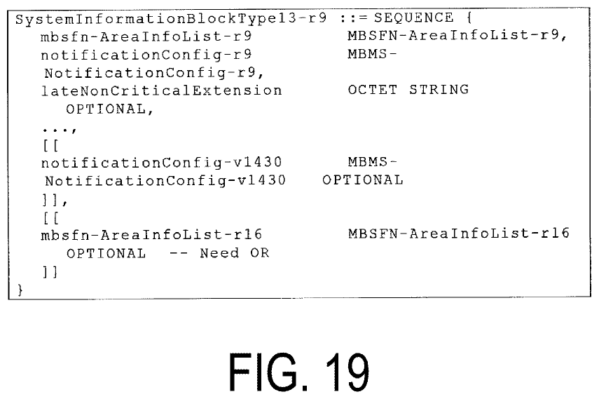

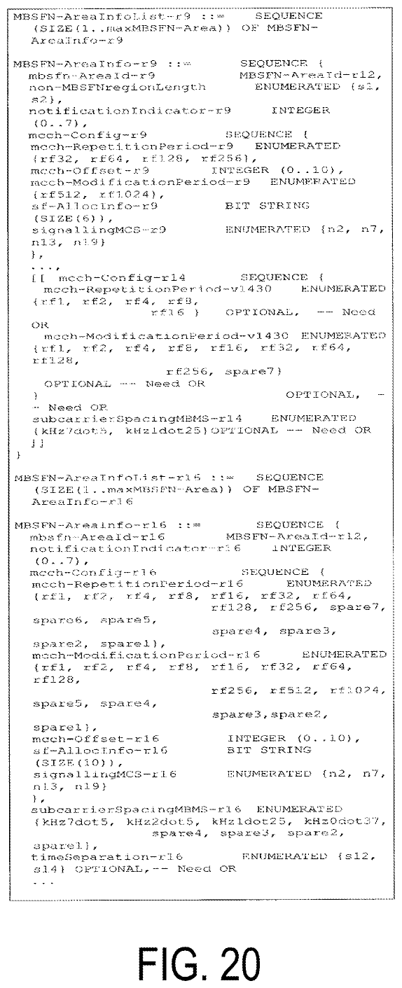

The content of SIB13 of LTE is shown in FIGS. 19 to 21.

### SIB15 of LTE

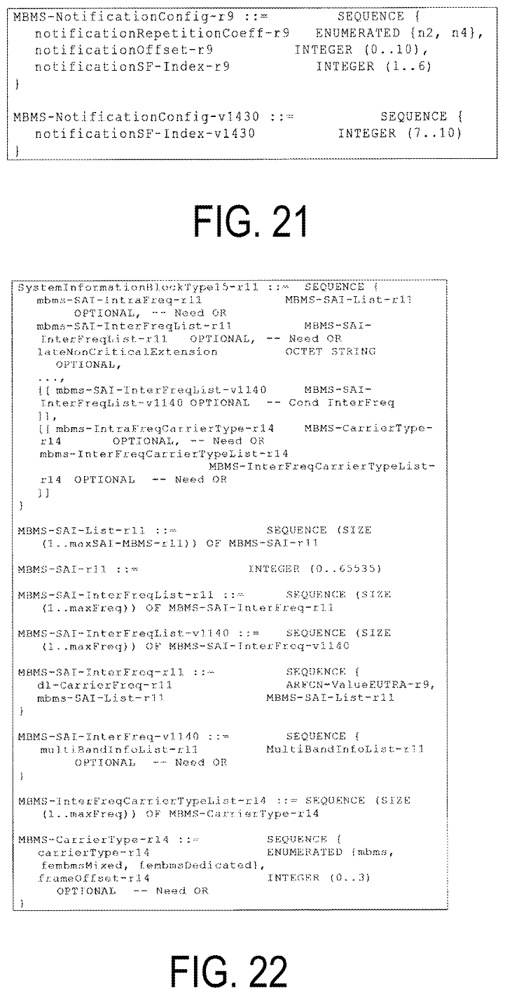

The content of SIB15 of LTE is shown in FIG. 22.

### SIB20 of LTE

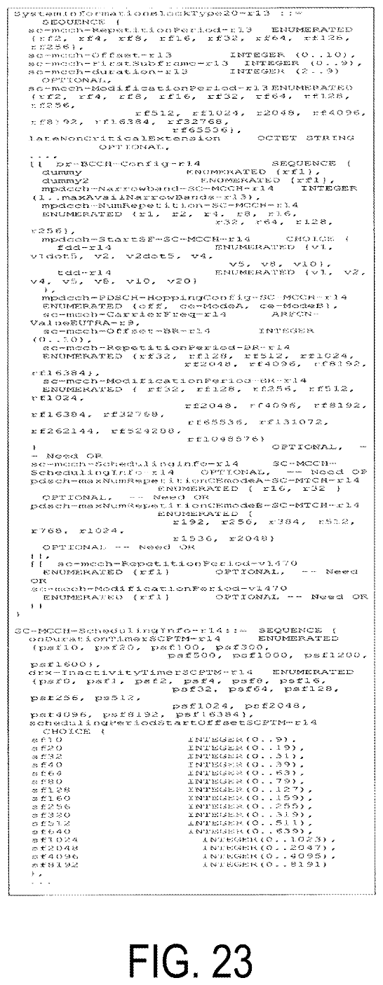

The content of SIB20 of LTE is shown in FIG. 23.

### SC-MCCH of LTE

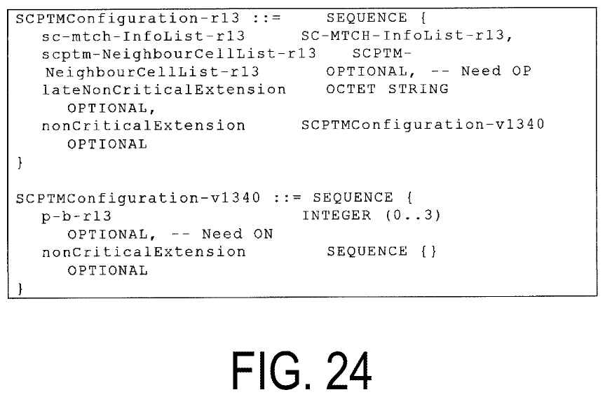

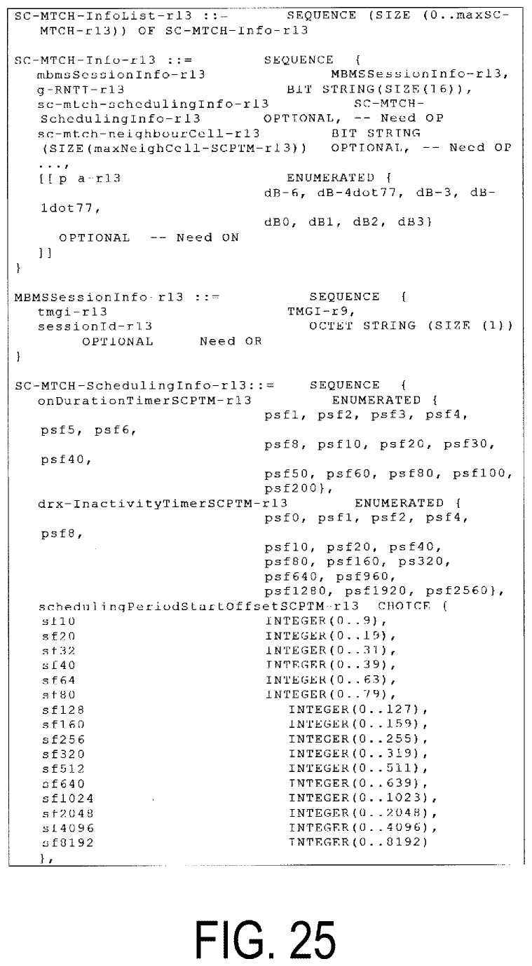

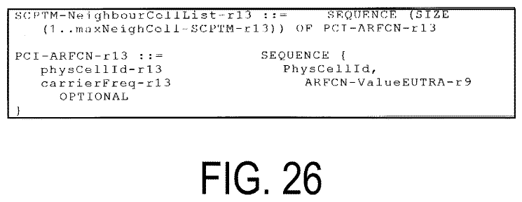

The content of SC-MCCH of LTE is shown in FIGS. 24 to 26.

### MBMS Interest Indication in LTE

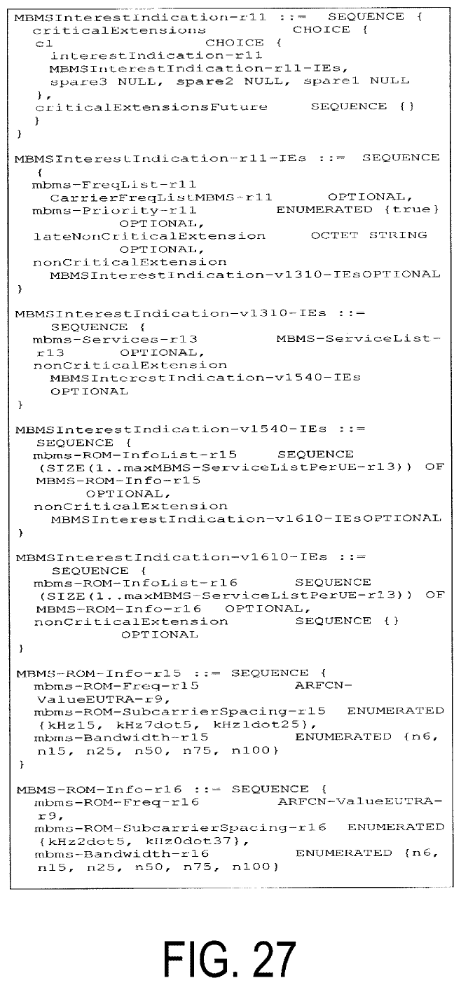

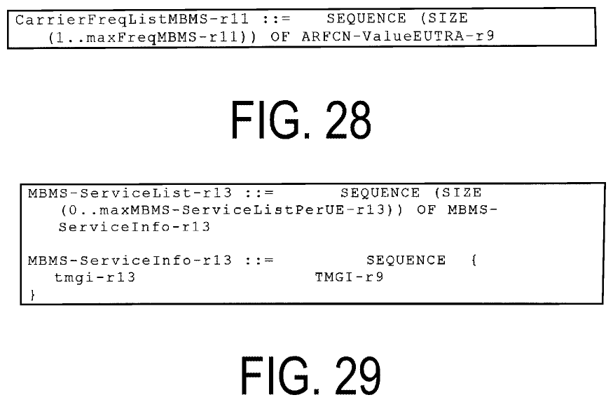

The content of the MBMS interest indication in LTE is shown in FIGS. 27 to 29.

### Cell Reselection Priority Processing in LTE

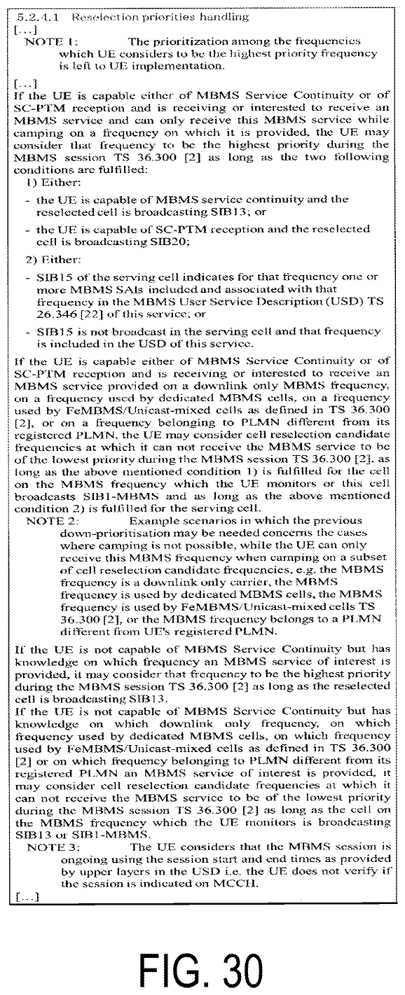

The priority of cell reselection at eMBMS frequencies in LTE is shown in FIG. 30.

### Cell-Level Prioritization in LTE

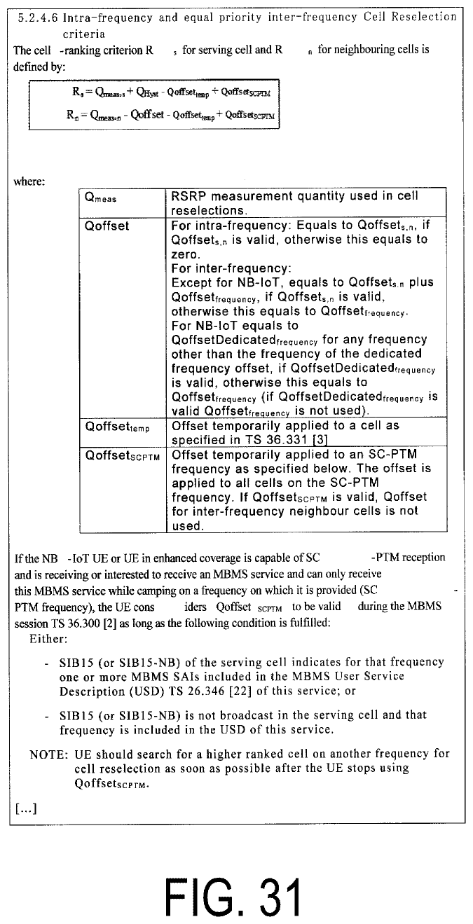

Priorities of cell levels in intra-frequency and intra-frequency cell reselection with an equal priority in NB-IOT in CE (including eMTC) and in LTE for UE are shown in FIG. 31.

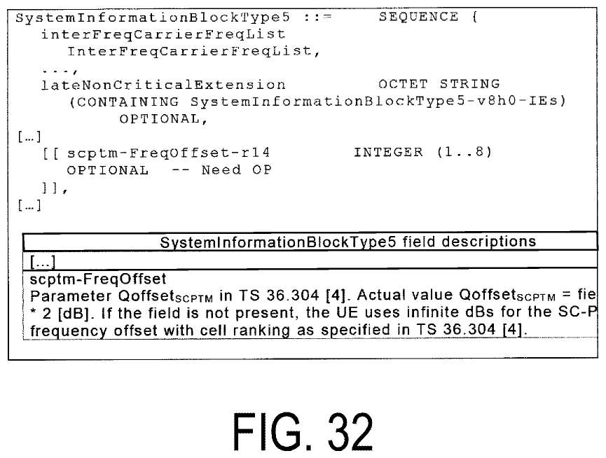

An example in which QoffsetSCPTM is set as an SCPTM frequency offset in SIB5 is shown in FIG. 32.

### REFERENCE SIGNS

1 Mobile communication system
10 RAN
20 CN
100 UE
110 Receiver
120 Transmitter
130 Controller
200 gNB
210 Transmitter
220 Receiver
230 Controller
240 Backhaul communicator

1. A communication method used in a mobile communication system supporting a multicast broadcast service (MBS), the communication method comprising:
transmitting, at a user equipment performing MBS reception or being interested in the MBS reception in a radio resource control (RRC) connected state, an RRC message to a base station,
wherein the transmitting comprises transmitting the RRC message comprising an information element related to a mode desired by the user equipment as an MBS delivery mode or an MBS reception mode from the base station.

2. The communication method according to claim 1,
wherein the RRC message comprises one or more MBS session identifiers where the user equipment is performing the MBS reception or is interested in the MBS reception, and the information element associated with each of the one or more MBS session identifiers.

3. The communication method according to claim 1,
wherein the information element is an information element indicating a delivery mode desired by the user equipment from among a plurality of delivery modes as the MBS delivery mode.

4. The communication method according to claim 3,
wherein the plurality of delivery modes comprise a delivery mode for a multicast session and a delivery mode for a broadcast session.

5. The communication method according to claim 3,
wherein the plurality of delivery modes comprise a delivery mode for the RRC connected state and a delivery mode for all RRC states.

6. The communication method according to claim 3,
wherein the plurality of delivery modes comprise a delivery mode where an MBS reception configuration is performed by using user equipment-dedicated signalling and a delivery mode where the MBS reception configuration is performed by using broadcast signalling.

7. The communication method according to claim 1,
wherein the information element is at least one selected from the group consisting of an information element indicating that the user equipment desires low-power consumption MBS reception as the MBS reception mode, an information element indicating that the user equipment desires MBS reception in an RRC idle state or an RRC inactive state, an information element indicating that the user equipment desires reception of MBS data delivered in Point-to-Point (PTP) manner, and an information element indicating that the user equipment does not desire reception of a certain MRB.

8. A communication method used in a mobile communication system supporting a multicast broadcast service (MBS), the communication method comprising:
transmitting, at a user equipment performing MBS reception or being interested in the MBS reception in a radio resource control (RRC) connected state, an RRC message to a base station,
wherein the transmitting comprises transmitting the RRC message comprising an information element indicating whether multicast reception is to be prioritized over unicast reception even when the user equipment is participating in a multicast session.

9. The communication method according to claim 8,
wherein the transmitting comprises
transmitting, when the user equipment is not participating in the multicast session, the RRC message comprising the information element and a different information element indicating an MBS session and/or an MBS frequency where the user equipment is performing the MBS reception or is interested in the MBS reception, and
transmitting, when the user equipment is participating in the multicast session, the RRC message comprising the information element without comprising the different information element.

10. A user equipment comprising:
a transmitter configured to transmit, when the user equipment performing MBS reception or being interested in the MBS reception in a radio resource control (RRC) connected state, an RRC message to a base station,
wherein the transmitter is configured to transmit the RRC message comprising an information element indicating whether multicast reception is to be prioritized over unicast reception even when the user equipment is participating in a multicast session.
